(19) United States
(12) Patent Application Publication
(10) Pub. No.: US 2025/0188860 A1
(43) Pub. Date: Jun. 12, 2025

(54) DIESEL EXHAUST FLUID TANK CONDUIT CONNECTED TO AIR COMPRESSOR AND METHOD

(71) Applicant: International Engine Intellectual Property Company, LLC, Lisle, IL (US)

(72) Inventors: Joshua David Manis, Bolingbrook, IL (US); Paul Boon Charintranond, Palatine, IL (US); Navtej Singh, Arlington Heights, IL (US)

(73) Assignee: International Engine Intellectual Property Company, LLC, Lisle, IL (US)

(21) Appl. No.: 18/537,119

(22) Filed: Dec. 12, 2023

(51) Int. Cl. F01N 3/20

(52) U.S. Cl. CPC F01N 3/2066; F01N 2610/02; F01N 2610/1406; F01N 2610/1466

(57) ABSTRACT

A diesel exhaust fluid tank vent line or conduit connected to an air compressor is provided for mitigating negative air pressure and cavitation in diesel exhaust fluid injection fluid tanks and associated components. The diesel exhaust fluid tank vent line or conduit connected to an air compressor may include a fluid tank, engine air intake filter, conduit and pressure regulation components. A method for mitigating negative air pressure and cavitation in diesel exhaust fluid injection tanks and associated components using the diesel exhaust fluid tank vent line or conduit connected to an air compressor is also provided.

### TECHNOLOGICAL FIELD

The present disclosure relates to a diesel exhaust fluid tank vent line or conduit connected to an air compressor. More particularly, the disclosure relates to mitigating negative air pressure and cavitation in diesel exhaust fluid tanks and associated components.

### BACKGROUND

Diesel Exhaust Fluid (DEF) plays a critical role in ensuring compliance with emissions regulations. The DEF is stored in a fluid tank and is dispensed to an exhaust system via a pump, such as to a DEF injector. Controlled amounts of DEF are injected into the exhaust system to reduce nitrogen oxide (NOx) emissions in accordance with EPA regulations. However, maintaining the integrity of the DEF injection system under the current state of the art presents various challenges.

First, DEF injection requires that the DEF must be substantially free of debris or other contaminants. The quantity and size of debris in the DEF must be carefully monitored to prevent damage to the DEF injector and preserve its durability. Any contaminants or foreign particles can disrupt the precision of the injection process, potentially leading to system malfunctions and non-compliance with emissions standards.

Additionally, as DEF is evacuated from a fluid tank, a negative pressure is created within the tank. If unmanaged, the fluid tank risks collapsing under this negative pressure. In the current state of the art, a vent is typically included to allow outside air to equalize the pressure within the tank. However, this venting mechanism can inadvertently introduce external debris into the DEF tank, potentially leading to operational problems. If a filter is applied to the vent located on the tank, it will add an additional component that needs to be uniquely maintained.

Furthermore, altitude can pose additional challenges in DEF systems of the current state of the art. At higher altitudes, lower atmospheric pressure can result in reduced pressure on the suction side of the DEF pump. Depending on the system's design, this low pressure can induce cavitation within the DEF pump. Cavitation occurs when the DEF reaches its boiling point due to the decreased pressure at higher altitudes, potentially causing damage to the pump hardware and improper injection of the DEF into the exhaust system.

Maintaining the integrity of DEF systems is crucial for emissions control and compliance.

What is needed is a system to mitigate undesired effects of negative pressure within a fluid tank capable of storing diesel exhaust fluid. What is needed is a system to provide filtered air to a fluid tank using an engine intake air filter. What is needed is a system to provide filtered air to a fluid tank capable of storing diesel exhaust fluid with positive pressure being compressed by a forced induction compressor of an engine. What is needed is a system and method to mitigate cavitation caused by high altitudes by supplying filtered air from a forced induction compressor of an engine.

### SUMMARY

An aspect of the disclosure provides a system to mitigate undesired effects of negative pressure within a fluid tank capable of storing diesel exhaust fluid. An aspect of the disclosure provides a system to provide filtered air to a fluid tank using an engine intake air filter. An aspect of the disclosure provides a system to provide filtered air to a fluid tank capable of storing diesel exhaust fluid with positive pressure being compressed by a forced induction compressor of an engine. An aspect of the disclosure provides a system and method to mitigate cavitation caused by high altitudes by supplying filtered air from a forced induction compressor of an engine.

Accordingly, the disclosure may feature a diesel exhaust fluid injection improvement system comprising filtered air, a conduit, and a fluid tank. The filtered air may be provided by an engine intake air filter. The conduit may provide a route through which at least part of the filtered air may pass. The fluid tank may be capable of storing diesel exhaust fluid and to receive the filtered air. A fluid tank pressure may be maintained within the fluid tank to at least ambient pressure via receiving the filtered air. The engine intake air filter may transform unconditioned air into filtered air to be received by the fluid tank via the conduit and an engine.

In another aspect, the conduit may include an engine conduit end and a fluid tank conduit end. The engine conduit end may be operatively attached to an air pathway located between the engine intake air filter and the engine to receive the filtered air. The fluid tank conduit end may be distal to the engine conduit end and operatively attached to the fluid tank to provide the filtered air to the fluid tank. The filtered air flows through the conduit from the engine conduit end to the fluid tank conduit end.

In another aspect, the filtered air may be compressed to above the ambient pressure prior to being received by the fluid tank.

In another aspect, the filtered air may be compressed to above 1 atmosphere.

In another aspect, a forced induction compressor may be operatively attached to an air box housing the engine intake air filter to compress the filtered air. An air pathway may be located between the forced induction compressor and the engine from which the filtered air that is compressed is passed to the fluid tank via the conduit.

In another aspect, the forced induction compressor may be at least partially provided by a compressor housing of a turbocharger.

In another aspect, a regulator may be located between the air pathway and the fluid tank to regulate the pressure level of the filtered air prior to being received by the fluid tank.

In another aspect, a pressure release valve may be operatively installed to the fluid tank to release the filtered air that exceeds a maximum pressure threshold.

According to an embodiment enabled by this disclosure, a system is provided to improve the function of diesel exhaust fluid injection. The system may include a filtered air source to provide filtered air. The system may also include a conduit through which at least part of the filtered air may pass. The system may include a fluid tank capable of storing diesel exhaust fluid and to receive the filtered air. Furthermore, the system may include a compressor to compress the filtered air above ambient pressure prior to being received by the fluid tank. Additionally, the system may include a regulator located between the compressor and the fluid tank to regulate the pressure level of the filtered air prior to being received by the fluid tank.

In another aspect, the filtered air source may be an engine intake air filter used to transform unconditioned air into the filtered air to be received by the fluid tank via the conduit and an engine. The conduit has an engine conduit end operatively attached to an air pathway located between the engine intake air filter and the engine to receive the filtered air. The conduit may also have a fluid tank conduit end that is distal to the engine conduit end and operatively attached to the fluid tank to provide the filtered air to the fluid tank. The filtered air can flow through the conduit from the engine conduit end to the fluid tank conduit end.

In another aspect, the filtered air may be compressed to above 1 atmosphere.

In another aspect, an air box may be provided comprising an engine air intake filter. Unconditioned air passing through the engine intake air filter may be conditioned into the filtered air to be received by an engine and the fluid tank. A forced induction compressor may be operatively attached to the air box to compress the filtered air. Additionally, an air pathway may be located between the forced induction compressor and the engine from which the filtered air that is compressed is passed to the fluid tank via the conduit.

In another aspect, the forced induction compressor may be at least partially provided by a compressor housing of a turbocharger.

In another aspect, a pressure release valve may be operatively installed to the fluid tank to release the filtered air that exceeds a maximum pressure threshold.

According to an embodiment enabled by this disclosure, a method is provided for improving the function of diesel exhaust fluid injection systems. The method may include (a) providing filtered air via an engine intake air filter. The method may also include (b) passing at least part of the filtered air through a conduit to a fluid tank capable of storing diesel exhaust fluid. Additionally, the method may include (c) receiving the filtered air by the fluid tank from the conduit. Furthermore, the method may include (d) maintaining a fluid tank pressure within the fluid tank to at least ambient pressure via receiving the filtered air.

In another aspect of the method, step (a) may further include (i) transforming unconditioned air via the engine intake air filter into the filtered air; and (ii) providing the filtered air to the fluid tank via the conduit and an engine. The conduit may have an engine conduit end operatively attached to an air pathway located between the engine intake air filter and the engine to receive the filtered air. The conduit may also have a fluid tank conduit end that is distal to the engine conduit end and operatively attached to the fluid tank to provide the filtered air to the fluid tank. The filtered air may flow through the conduit from the engine conduit end to the fluid tank conduit end.

In another aspect, the method may include (e) compressing the filtered air to above the ambient pressure prior to being received by the fluid tank.

In another aspect of the method, step (e) may further include (i) passing the unconditioned air through an air box comprising the engine intake air filter to condition the unfiltered air into the filtered air to be received by the engine and the fluid tank. Step (e) may additionally include (ii) compressing the filtered air via a forced induction compressor operatively attached to the air box. Furthermore, step (e) may include (iii) passing the filtered air that is compressed to the fluid tank via the conduit from the air pathway.

In another aspect of the method, the forced induction compressor may be at least partially provided by a compressor housing of a turbocharger.

In another aspect, the method may further include (f) regulating a pressure level of the filtered air prior to being received by the fluid tank via a regulator located between the air pathway and the fluid tank. The method may additionally include (g) releasing the filtered air that exceeds a maximum pressure threshold via a pressure release valve operatively installed to the fluid tank.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

### BRIEF DESCRIPTION OF THE DRAWINGS

FIG. 1 is a block diagram view of an illustrative engine having forced induction, according to an embodiment of this disclosure.

FIG. 2 is a block diagram view of an illustrative diesel exhaust fluid injection system being supplied filtered air from an air box, according to an embodiment of this disclosure.

FIG. 3 is a block diagram view of an illustrative diesel exhaust fluid injection system being supplied filtered air that is compressed from an air pathway, according to an embodiment of this disclosure.

FIG. 4 is a flow chart view of an illustrative method of providing filtered air to a fluid tank, according to an embodiment of this disclosure.

FIG. 5 is a flow chart view of an illustrative method of providing filtered air to a fluid tank that is compressed from a forced induction compressor, according to an embodiment of this disclosure.

### DETAILED DESCRIPTION

The following disclosure is provided to describe various embodiments of a diesel exhaust fluid tank conduit connected to an air compressor or other filtered air source. Skilled artisans will appreciate additional embodiments and uses of the present systems and methods that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term diesel exhaust fluid, as it is used throughout this disclosure, is defined as a chemical solution, typically comprising urea and deionized water, used in diesel engines equipped with selective catalytic reduction (SCR) systems to reduce nitrogen oxide (NOx) emissions into nitrogen and water. The term filtered air, as it is used throughout this disclosure, is defined as air that has been passed through a filter or filtration system to remove impurities, particles, or contaminants, resulting in cleaner air than unconditioned air.

The term conduit, as it is used throughout this disclosure, is defined as a channel, pipe, or tube used to guide, contain, and transport fluids such as liquids or gases from one location to another. The term ambient pressure, as it is used throughout this disclosure, is defined as pressure of the surrounding air or environment at a location, which is typically about equal to atmospheric pressure at that location.

The term forced induction compressor, as it is used throughout this disclosure, is defined as a device, such as a supercharger or a turbocharger, used to increase the air pressure and density supplied to an internal combustion engine. The term turbocharger, as it is used throughout this disclosure, is defined as an embodiment of a forced induction compressor that increases the pressure of air by rotating an impeller driven by exhaust gases. The term regulator, as it is used throughout this disclosure, is defined as a device that controls and maintains a target pressure level in a pneumatic system by adjusting the flow or release of air to reduce pressure fluctuations. The term pressure level, as it is used throughout this disclosure, is defined as a measure of force per unit area exerted by a fluid, gas, or liquid within a confined space.

Various aspects of the present disclosure will now be described in detail, without limitation. In the following disclosure, a diesel exhaust fluid tank vent line or conduit connected to an air compressor will be discussed. Those of skill in the art will appreciate alternative labeling of the diesel exhaust fluid tank vent line or conduit connected to an air compressor as a fluid tank vent line system, powertrain air compressor to supply a fuel tank, fuel tank filtered and compressed air supply system, or other similar names. Similarly, those of skill in the art will appreciate alternative labeling of the diesel exhaust fluid tank vent line or conduit connected to an air compressor as a method of pressure control for a fluid tank, method of mitigating negative pressure and cavitation in a diesel exhaust fluid tank, method for improving the function of a diesel exhaust fluid injection system, method, operation, or other similar names. Skilled readers should not view the inclusion of any alternative labels as limiting in any way.

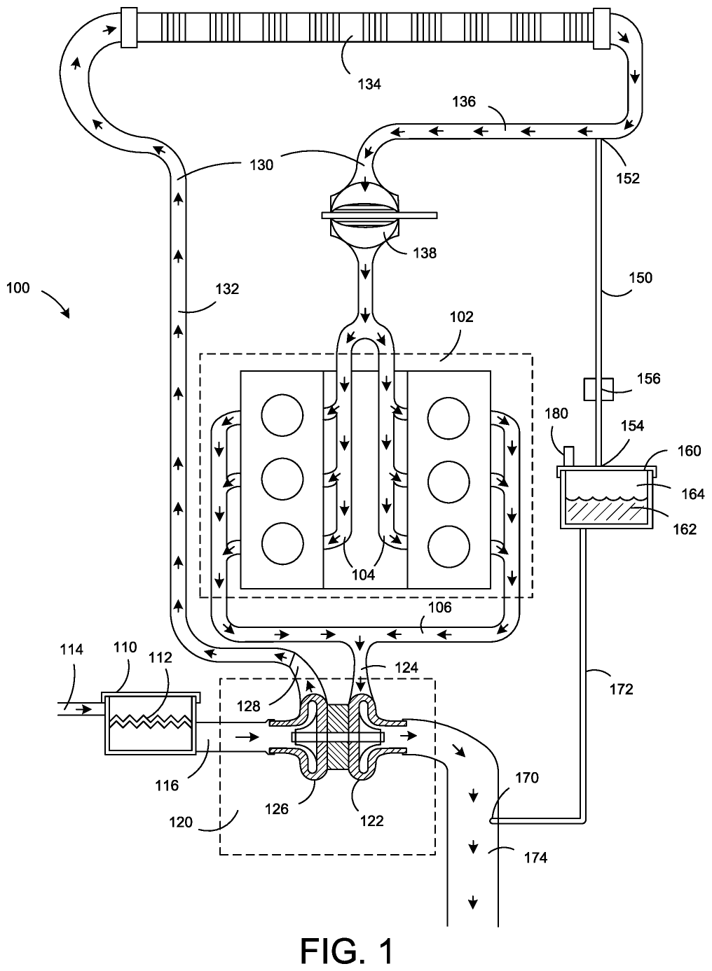

Referring now to FIGS. 1-5, the diesel exhaust fluid tank vent line or conduit connected to an air compressor will now be discussed in more detail. The diesel exhaust fluid tank vent line or conduit connected to an air compressor may include a fluid tank, engine air intake filter, conduit, pressure regulation components, and additional components that will be discussed in greater detail below. The diesel exhaust fluid tank vent line or conduit connected to an air compressor may operate one or more of these components interactively with other components for mitigating negative air pressure and cavitation in diesel exhaust fluid injection fluid tanks and associated components.

An illustrative engine will now be discussed in greater detail, which will be used to illustrate various applications discussed throughout this disclosure. FIG. 1 highlights an example engine, which may also be shown in other figures. Those of skill in the art will appreciate that while an example is given of a diesel automotive engine, the teaching of this disclosure could be applied broadly to virtually any engine system that would also benefit from diesel exhaust fluid injection, without limitation.

Referring now to FIG. 1, the engine 100 may have a powertrain 102 that includes a number of cylinders. The cylinders in the powertrain 102 may be fluidly connected to an intake system 104 and to an exhaust system 106. A forced induction compressor may be included. In the example of engine 100, the forced induction compressor is provided by turbocharger 120, which includes a turbine housing 122 having a turbine inlet 124 connected to the exhaust system 106 and a compressor housing 126 connected to an intake system 104 via a compressor outlet 128. An engine intake air filter 112 may receive unconditioned air 114, which may pass through the engine intake air filter 112 to be conditioned into filtered air 116. In some embodiments, the engine intake air filter 112 may be housed within an air box 110. The engine intake air filter 112 may be connected to an inlet of the compressor housing 126. After driving the turbine housing 122 of the turbocharger 120, the exhaust air may continue through an exhaust pathway 174 where it can be expelled from the vehicle, for example into the atmosphere.

Viewing the intake system 104 in greater detail, a compressor outlet 128 of the compressor housing 126 is connected to an air pathway 130. In the example provided by engine 100, the air pathway 130 includes a hot air pathway 132, a cool air pathway 136, and associated components. An air cooler 134, for example an intercooler, may receive filtered air through a hot air pathway 132 via an air cooler inlet. The air cooler 134 may reduce the temperature of received filtered air, thereby increasing the density of the filtered air, as will be appreciated by those of skill in the art. An outlet of the air cooler 134 may be connected to an intake throttle 138 through the cool air pathway 136.

A conduit 150 may be operatively connected between the air pathway, for example the cool air pathway 136 of the air pathway, and a fluid tank 160. Filtered and/or compressed air may be provided from the air pathway, such as the cool air pathway 136, to the fluid tank 160. For example, the conduit 150 may connect from an engine conduit end 152 to the cool air pathway 136. The conduit 150 may extend a given length from the air pathway 130 to the fluid tank 160, allowing the filtered and/or compressed air to pass through an internal volume of the conduit 150, where it may exit into fluid tank 160 via the conduit 150 at its fluid tank conduit end 154. In one embodiment, a regulator 156 may be provided along the conduit 150, for example, at a target location at or between the engine conduit end 152 and/or fluid tank conduit end 154. In one embodiment, the regulator 156 may be located at or near the point where the engine conduit end 152 of the conduit 150 interfaces with the air pathway 130.

The fluid tank 160 may be provided to hold DEF 162, with the remainder of the volume provided by the fluid tank 160 being filled with air 164. The fluid tank 160 may be operatively connected to a DEF injector 170 via a DEF fluid line 172. The DEF injector 170 may be at least partially inserted into the exhaust pathway 174 to disburse DEF into the exhaust gases, which may at least partially neutralize nitrous oxide (NOx) emission otherwise present in the exhaust gases. A pressure regulator valve 180 may be installed to the fluid tank, which may allow the venting of excess gases if a maximum pressure threshold is reached or surpassed.

The air pathway may additionally connect to an intake system 104 of the powertrain 102. During normal engine operation, cooled intake air enters the powertrain 102 respective to a level of openness provided by an intake throttle 138. When the engine 100 operates at or near an idle condition, when engine speed is low and there is little to no torque load on the engine, the intake throttle 138 may be substantially closed. When the engine 100 operates above an idle condition, the intake throttle 138 may be substantially or more than 5% open. Cooled intake air exiting the air cooler 134 may pass through the intake throttle 138 via the cool air pathway 136, where it can be consumed by the powertrain 102.

The fluid tank will now be discussed in greater detail. FIGS. 1-3 highlight examples of the fluid tank, which may also be shown in other figures. The engine 100, 200, 300 may include a diesel exhaust fluid (DEF) tank 160, 260, 360, a component in modern diesel engines equipped with selective catalytic reduction (SCR) systems. In one embodiment, DEF may be provided as a solution including at least urea and deionized water. The fluid tank 160, 260, 360 stores DEF, which is used to reduce harmful nitrogen oxide (NOx) emissions produced during the combustion process in diesel engines.

The fluid tank 160, 260, 360 may serve as a storage reservoir for the DEF. The fluid tank 160, 260, 360 may be constructed using virtually any durable materials, for example, plastic or stainless steel. The fluid tank 160, 260, 360 may be sized depending on the vehicle's design, exhaust volume, intended usage, and/or other considerations.

When a diesel engine is running, a small amount of DEF can be drawn from the fluid tank 160, 260, 360 along a DEF fluid line 172, 272, 372 to be injected via an injector 170, 270, 370 into the exhaust pathway 174, 274, 374 before it reaches the SCR catalyst. This injection may be carefully controlled by the engine's electronic control unit (ECU) to ensure precise dosing. The exhaust gases, along with the injected DEF, may enter the SCR catalyst of the vehicle's exhaust system. Inside the catalyst, the DEF reacts with the NOx emissions, causing a chemical reaction that converts at least part of the NOx into harmless nitrogen gas (N2) and water vapor (H2O).

As will be appreciated by skilled artisans, DEF fluid must be of high purity to ensure proper operation of the SCR system. The fluid tank 160, 260, 360 may be designed to protect the DEF from contamination and maintain its quality, such as by being sealed to prevent moisture and impurities from entering. Over time, the DEF in the tank is consumed as the engine uses it for emissions reduction. As the DEF level decreases, a negative pressure may be created within the fluid tank 160, 260, 360. This negative pressure may be offset by introduction of air at or above ambient temperature, for example, by venting and/or compression. In at least one embodiment, air may be provided to the fluid tank 160, 260, 360 via a conduit 150, 250, 350.

The engine air intake filter and associated components will now be discussed in greater detail. FIGS. 1-3 highlight examples of the engine air intake filter, air box, air pathway, and other components, which may also be shown in other figures. The primary role of an engine intake air filter 112, 212, 312 is to ensure that only clean, debris-free air enters the powertrain 102, 202, 302. Skilled artisans will appreciate the engine intake air filter 112, 212, 312 serves as a protective barrier between the unconditioned air present in the environment and the internal components of the engine. Typically, an engine intake air filter 112, 212, 312 is housed in an air box 110, 210, 310, which may draw in unconditioned air 114, 214, 314 to pass through the engine intake air filter 112, 212, 312 to produce the filtered air 116, 216, 316. The filtered air 116, 216, 316 may then be routed to various components of the powertrain, such as an intake system 104, 204, 304, turbocharger 120, 220, 320, other forced induction compressor, via an exhaust system 106, 206, 306 or other components of the engine such as a DEF fluid tank 160, 260, 360. Skilled artisans will appreciate that embodiments including a turbocharger 120, 220, 320 may provide forced induction compression via a compression housing 126, 226, 326 that may be driven by a turbine located in a turbine housing 122, 222, 322.

The engine intake air filter 112, 212, 312 is typically made from fibrous materials, designed to trap and hold the contaminants found in unconditioned air. As unconditioned air 114, 214, 314 flows through these fibers, particles larger than the spaces between the fibers get trapped, allowing only filtered air 116, 216, 316 to pass through the engine intake air filter 112, 212, 312. Over time, the engine intake air filter 112, 212, 312 will collect debris, which designates it to be replaced or cleaned at scheduled maintenance. Since maintenance of the engine intake air filter is already scheduled as routine maintenance for an engine, any components receiving the filtered air, for example the fluid tank 160, 260, 360, will advantageously have its filtering component effectively maintained as a part of the normal course of engine maintenance.

The engine intake air filter 112, 212, 312 may be encased within an air box 110, 210, 310, which is typically made of plastic or metal. The air box 110, 210, 310 provides structural support for the engine intake air filter 112, 212, 312, secures it in place, and ensures that all the incoming unconditioned air 114, 214, 314 passes through the engine intake air filter 112, 212, 312 to be conditioned into the filtered air 116, 216, 316.

The conduit will now be discussed in greater detail. FIGS. 1-3 highlight examples of the conduit, which may also be shown in other figures. Filtered air that has passed through the engine intake air filter 112, 212, 312 may be subsequently passed through a conduit 150, 250, 350 to a fluid tank 160, 260, 360, advantageously maintaining the cleanliness and quality of the DEF stored in the fluid tank 160, 260, 360. The conduit 150, 250, 350 may be provided as a pipe or tubing designed to transport air. At the start of the conduit 150, 250, 350, near the engine conduit end 152, 252, 352, an inlet or opening may be provided through which filtered air is drawn. In some embodiments, the filtered air may be compressed, such as via a forced induction compressor.

Once the filtered air has passed through the inlet at the engine conduit end 152, 252, 352, the filtered air is transported through the conduit 150, 250, 350 toward the fluid tank 160, 260, 360. The conduit is typically designed to withstand the airflow and maintain the integrity of the filtered air. Near the fluid tank end 154, 254, 354 of the conduit 150, 250, 350, it may connect to the fluid tank 160, 260, 360. Example connections include, without limitation, a dedicated port, valve, or fitting designed to introduce the filtered air into the tank.

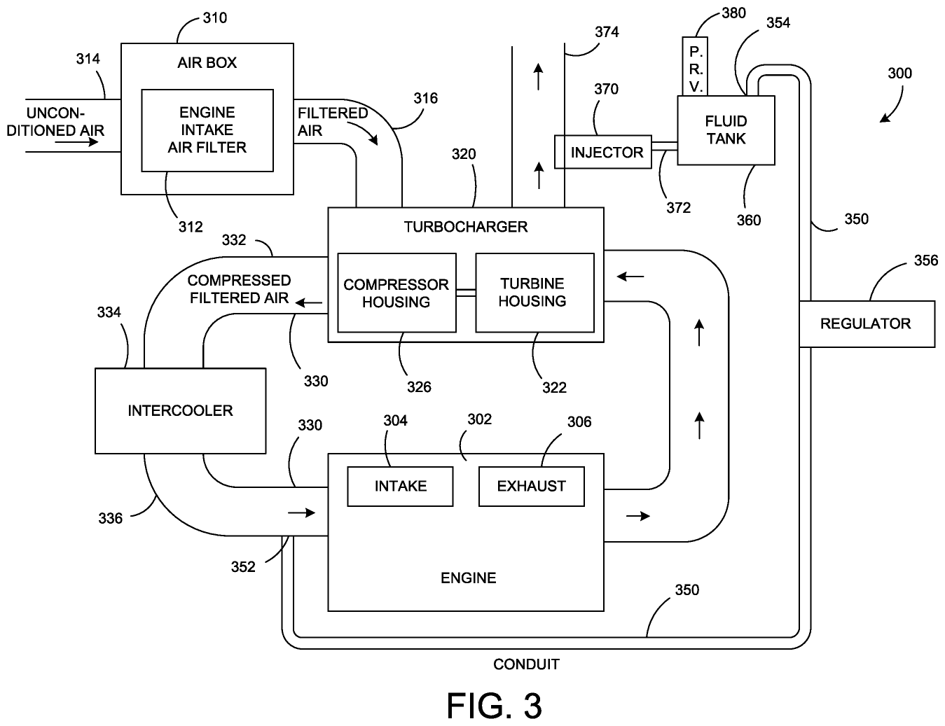

The pressure regulation components will now be discussed in greater detail. FIGS. 1 and 3 highlight examples of the pressure regulation components, which may also be shown in other figures. A regulator 156, 356 may be provided at one of the conduit ends or at a location along the conduit 150, 350 to control the pressure of filtered air supplied to the fluid tank 160, 360. For example, in embodiments where the filtered air is compressed prior to being received by the conduit 150, 350, the regulator 156, 356 may control a pressure level to mitigate the risk of the pressure level within the fluid tank 160, 360 exceeding a maximum pressure threshold. In embodiments where the filtered air is compressed prior to being received by the conduit 150, 350, the filtered air delivered to the fluid tank 160, 360 may be above ambient pressure. In some embodiments, the filtered air delivered to the fluid tank 160, 360 may be at or above 1 atmosphere, which may be above the ambient pressure when operated at elevated altitudes.

As will be appreciated by those of skill in the art, an air pressure regulator is a device designed to control and maintain a target pressure level in a pneumatic system. It operates by reducing the incoming high-pressure air to a target lower pressure, ensuring that downstream components and equipment receive a consistent and controlled air supply. High-pressure compressed air enters the regulator through the inlet port from the source, typically an air compressor, such as a forced induction compressor. The outlet port is connected to the downstream components or equipment that utilize the regulated air supply, for example, a fluid tank.

The fluid tank 160, 260, 360 may also have a pressure release valve 180, 280, 380 or breather to release any excess pressure, advantageously reducing the likelihood of the pressure level within a fluid tank 160, 260, 360 exceeding a maximum threshold temperature. As will be appreciated by those of skill in the art, a pressure release valve 180, 280, 380, often referred to simply as a safety valve or pressure relief safety valve, may protect the fluid tank 160, 260, 360 from overpressure conditions by relieving excess pressure when it exceeds a maximum pressure threshold. In one example, the pressure release valve 180, 280, 380 may be constructed with a spring or weight-loaded mechanism to apply a force on the sealing element to keep it closed under normal operating conditions. The pressure release valve 180, 280, 380 may include an adjustment mechanism that allows operators to set the target maximum pressure threshold at which the pressure release valve 180, 280, 380 will open. When the pressure within the fluid tank 160, 260, 360 surpasses the maximum pressure threshold, the force exerted by the pressure acting on the sealing element overcomes the opposing force applied by the spring or weight, causing the pressure release valve 180, 280, 380 to lift or open and exhaust the excess pressure.

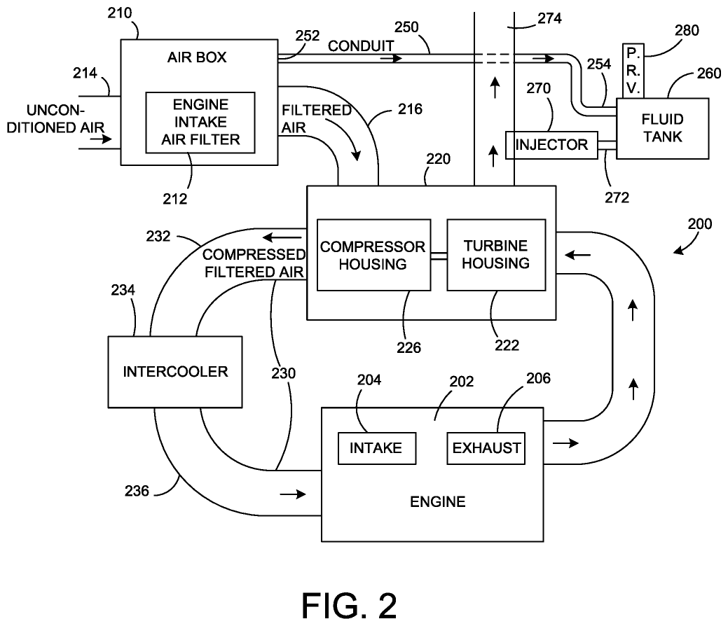

Referring now to the example shown in FIG. 2, an illustrative system enabled by this disclosure, wherein the filtered air is sourced from an air box, will now be discussed, without limitation. In one embodiment, as illustrated by engine 200, the conduit 250 may extend from a filtered air source, such as provided by an air box 210 that may include an engine intake air filter 212, to the fluid tank 260. For example, the conduit 250 may be operatively attached to an air pathway located between the engine intake air filter and the powertrain 202 to receive the filtered air at its engine conduit end 252. The fluid tank 260 may receive the filtered air from the conduit 250 via its fluid tank conduit end 254 that is distal to the engine conduit end 252 and operatively attached to the fluid tank 260 to provide the filtered air to the fluid tank 260. The conduit may be virtually any practical length such to sufficiently connect the fluid tank 260 to the filtered air source, for example, air box 210, wherein the filtered air flows through the conduit 250 from the engine conduit end 252 to the fluid tank conduit end 254. Filtered air that is not received by the conduit 250 may be directed to the air pathway 230, which may include a hot air pathway 232, air cooler 234, cool air pathway 236, and/or other components to direct the filtered air to the powertrain 202.

Referring now to the example shown in FIG. 3, an illustrative system enabled by this disclosure, wherein the filtered air is sourced from a forced induction compressor, will now be discussed, without limitation. In one embodiment, as illustrated by engine 300, the conduit 350 may extend from a filtered air source, such as provided by an air pathway 330 located after a forced induction compressor, such as a turbocharger 320, without limitation. The forced induction compressor may receive filtered air from an engine intake air filter 312, which may be housed in an air box 310 to the fluid tank 260. For example, the conduit 350 may be operatively attached to an air pathway 330 located between a turbocharger 320 and the powertrain 302 to receive the filtered air at its engine conduit end 352. The fluid tank 360 may receive the filtered air from the conduit 350 via its fluid tank conduit end 354 that is distal to the engine conduit end 352 and operatively attached to the fluid tank 360 to provide the filtered air to the fluid tank 360. The conduit 350 may be virtually any practical length such to sufficiently connect the fluid tank 360 to the filtered air source, for example, air pathway 330, wherein the filtered air flows through the conduit 350 from the engine conduit end 352 to the fluid tank conduit end 354. Filtered air that is not received by the conduit 350 from the air pathway 330, which may include a hot air pathway 332, air cooler 334, cool air pathway 336, and/or other components, may be directed to the powertrain 302.

In one embodiment, discussed along with illustrative engine 300 shown in FIG. 3, at least part of the filtered air may be directed from the hot air pathway 332 to the fluid tank to provide a heat source. Skilled artisans will appreciate that, in cold weather conditions, DEF can freeze. To mitigate negative effects of frozen DEF, many DEF tanks are equipped with a heating element or a heater that warms the DEF fluid to maintain its liquid state. This ensures that the SCR system can continue to function effectively in cold climates. In embodiments provided by this disclosure, provision of heated filtered air from the hot air pathway 332 of the air pathway 330 may assist with maintaining a target DEF temperature. In additional embodiments, the conduit 350 may have selectable origins, allowing the provision of heated filtered air sourced from the hot air pathway 332, cooled filtered air sourced from the cool air pathway 336, or varied temperature provided by blending air sourced from both the hot air pathway 332 and cool air pathway 336.

Those of skill in the art will appreciate additional locations where the conduit may connect to aspects of the intake system of an engine to receive filtered air. For example, in some embodiments, the conduit may receive the filtered air before such air may enter an intercooler. In such examples, the provision of heated air may assist with keeping the DEF at a target temperature. In other embodiments, the conduit may connect to multiple points along the intake system, for example, before and after an intercooler of a forced induction application. In this example, higher temperature filtered air may be sourced when it is desired to increase the temperature of DEF held within the fluid tank, which may be transitioned to a lower temperature filtered air sourced from after the intercooler, without limitation. In some embodiments, compression of the filtered air may be provided by a discrete compressor, which may be driven mechanically, electrically, hydraulically, and/or otherwise, as will be appreciated by those having skill in the art after reading this disclosure.

In operation, a method is provided for mitigating negative air pressure and cavitation in diesel exhaust fluid injection tanks and associated components. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having read this disclosure. Such additional methods are intended to be included by this disclosure.

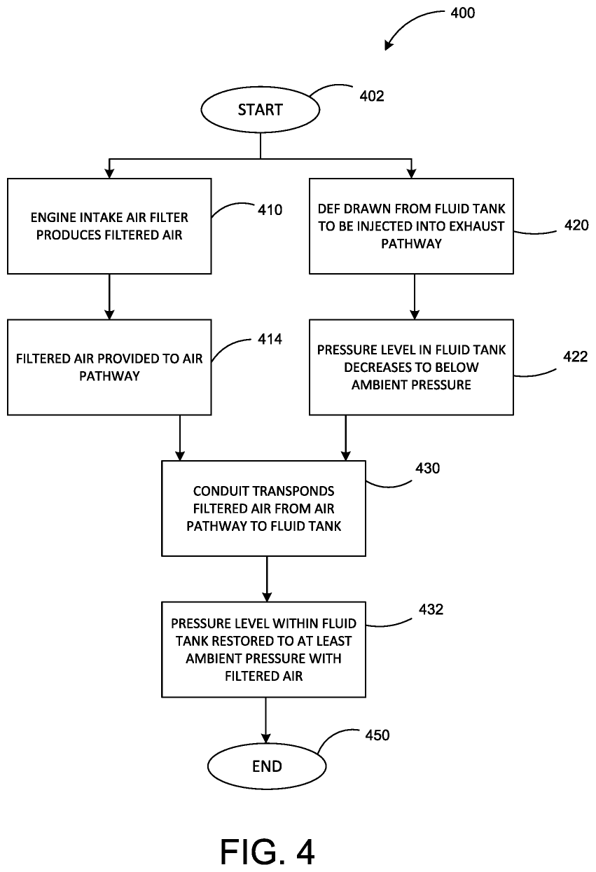

Referring now to flowchart 400 of FIG. 4, an example method for providing filtered air to a fluid tank will be described, without limitation. Starting with Block 402, the operation may begin by unconditioned air passing through an engine intake air filter to produce filtered air (Block 410). The filtered air may then be provided to an air pathway (Block 414). Meanwhile, DEF may be drawn from a fluid tank to be injected into an exhaust pathway (Block 420). As DEF is drawn from the fluid tank, the pressure level in the fluid tank may decrease to below ambient pressure (Block 422).

The operation may continue by passing filtered air along the conduit from the air pathway to the fluid tank (Block 430). The pressure level within the fluid tank may be restored to a target pressure level, which may at least be ambient pressure, by receiving the filtered air via the conduit (Block 432). The operation may then terminate at Block 450.

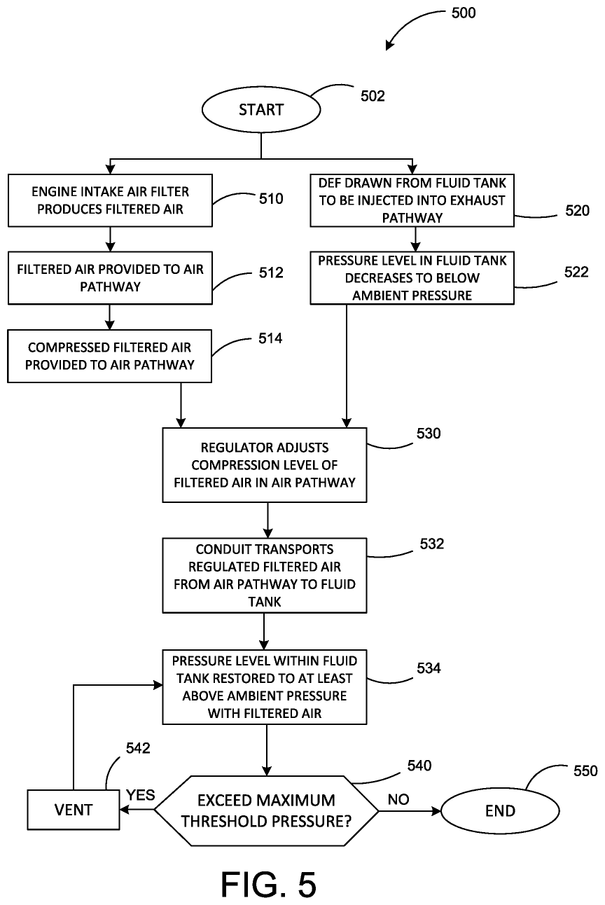

Referring now to flowchart 500 of FIG. 5, an example method for providing filter air to a fluid tank that is compressed from a forced induction compressor will be described, without limitation. Starting with Block 502, the operation may begin by unconditioned air passing through an engine intake air filter to produce filtered air (Block 510). The filtered air may then be provided to a forced induction compressor, for example, a turbocharger (Block 512). The compressed filtered air may then be provided to an air pathway (Block 514). Meanwhile, DEF may be drawn from a fluid tank to be injected into an exhaust pathway (Block 520). As DEF is drawn from the fluid tank, the pressure level in the fluid tank may decrease to below a target pressure level (Block 522).

The operation may continue by at least part of the filtered air that is compressed and within the air pathway being adjusted by a regulator to a target level of compression to be provided to the fluid tank via the conduit (Block 530). The conduit may then transport regulated filtered air from the air pathway to the fluid tank (Block 532). Those of skill in the art will appreciate that the regulator may be located virtually any place along the conduit between the air pathway and the fluid tank, without limitation. The pressure level within the fluid tank may be restored to a target pressure level, which may be above ambient pressure, for example at least 1 atmosphere, by receiving the filtered air via the conduit (Block 534).

The operation may then determine whether the pressure level within the fluid tank exceeds a maximum pressure threshold (Block 540). If it is determined at Block 540 that a maximum pressure threshold has been exceeded, the pressure release valve may vent some of the excess air and thus lower the pressure level within the fluid tank (Block 542), after which the operation may return to Block 534. If it is determined at Block 540 that the pressure in the fluid tank has not exceeded the maximum pressure threshold, the operation may then terminate at Block 550.

1. A diesel exhaust fluid injection improvement system comprising:
filtered air provided by an engine intake air filter;
an air pathway comprising of a hot air pathway upstream of an intercooler and a cool air pathway downstream of the intercooler;
a conduit with a first conduit end originating at least one of the engine intake air filter, the hot air pathway and the cool air pathway through which at least part of the filtered air passes;
a fluid tank capable of storing diesel exhaust fluid and to receive the filtered air;
wherein a fluid tank pressure is maintained within the fluid tank to at least ambient pressure via receiving the filtered air;
wherein the engine intake air filter transforms unconditioned air into the filtered air to be received by the fluid tank via the conduit and an engine; and
wherein the filtered air provides a heat source to the fluid tank to maintain a target diesel exhaust fluid temperature.

2. The system of claim 1:
wherein the air pathway is located between the engine intake air filter and the engine; and
wherein the conduit additionally comprises:
a fluid tank conduit end that is distal to the first conduit end and operatively attached to the fluid tank to provide the filtered air to the fluid tank; and
wherein the filtered air flows through the conduit from the first conduit end to the fluid tank conduit end.

3. The system of claim 1, wherein the filtered air is compressed to above the ambient pressure prior to being received by the fluid tank.

4. The system of claim 3, wherein the filtered air is compressed to above 1 atmosphere.

5. The system of claim 3, further comprising:
a forced induction compressor operatively attached to an air box housing the engine intake air filter to compress the filtered air; and
the air pathway located between the forced induction compressor and the engine from which the filtered air that is compressed is passed to the fluid tank via the conduit.

6. The system of claim 5, wherein the forced induction compressor is at least partially provided by a compressor housing of a turbocharger.

7. The system of claim 5, further comprising:
a regulator located between the air pathway and the fluid tank to regulate a pressure level of the filtered air prior to being received by the fluid tank.

8. The system of claim 1, further comprising:
a pressure release valve operatively installed to the fluid tank to release the filtered air that exceeds a maximum pressure threshold.

9. A system to improve function of diesel exhaust fluid injection comprising:
a filtered air source to provide filtered air;
an intercooler to regulate the temperature of the filtered air;
an air pathway comprising of a hot air pathway upstream of the intercooler and a cool air pathway downstream of the intercooler;
a conduit with a first conduit end originating at least one of the filtered air source, the hot air pathway and the cool air pathway through which at least part of the filtered air passes;
a fluid tank capable of storing diesel exhaust fluid and to receive the filtered air;
a compressor to compress the filtered air above ambient pressure prior to being received by the fluid tank; and
a regulator located between the compressor and the fluid tank to regulate a pressure level of the filtered air prior to being received by the fluid tank.

10. The system of claim 9:
wherein the filtered air source is an engine intake air filter used to transform unconditioned air into the filtered air to be received by the fluid tank via the conduit and an engine;
wherein the air pathway is located between the engine intake air filter and the engine to receive the filtered air; and
wherein the conduit additionally comprises:
a fluid tank conduit end that is distal to the first conduit end and operatively attached to the fluid tank to provide the filtered air to the fluid tank; and
wherein the filtered air flows through the conduit from the first conduit end to the fluid tank conduit end.

11. The system of claim 9, wherein the filtered air is compressed to above 1 atmosphere.

12. The system of claim 9, further comprising:
an air box comprising an engine air intake filter, wherein unconditioned air passing through the engine intake air filter is conditioned into the filtered air to be received by the engine and the fluid tank;
the compressor comprising a forced induction compressor operatively attached to the air box to compress the filtered air; and
the air pathway further located between the forced induction compressor and the engine from which the filtered air that is compressed is passed to the fluid tank via the conduit.

13. The system of claim 12, wherein the forced induction compressor is at least partially provided by a turbocharger.

14. The system of claim 9, further comprising:
a pressure release valve operatively installed to the fluid tank to release the filtered air that exceeds a maximum pressure threshold.

15. A method for improving function of diesel exhaust fluid injection systems comprising:
(a) providing filtered air via an engine intake air filter;
(b) passing at least part of the filtered air through a conduit with a first conduit end originating from at least one of the engine intake air filter, a hot air pathway of an air pathway upstream of an intercooler, and a cool air pathway of the air pathway downstream of the intercooler, to a fluid tank capable of storing diesel exhaust fluid; the air pathway extending between the engine intake air filter and an engine to receive the filtered air;
(c) receiving the filtered air by the fluid tank from the conduit;
(d) maintaining a fluid tank pressure within the fluid tank to at least ambient pressure via receiving the filtered air; and
(e) maintaining a target diesel exhaust fluid temperature within the fluid tank.

16. The method of claim 15:
wherein step (b) further comprises:
(i) transforming unconditioned air via the engine intake air filter into the filtered air; and
(ii) providing the filtered air to the fluid tank via the conduit;
wherein the conduit additionally comprises:
a fluid tank conduit end that is distal to the first conduit end and operatively attached to the fluid tank to provide the filtered air to the fluid tank; and
wherein the filtered air flows through the conduit from the first conduit end to the fluid tank conduit end.

17. The method of claim 16, further comprising:
(f) compressing the filtered air to above the ambient pressure prior to being received by the fluid tank.

18. The method of claim 17:
wherein step (f) further comprises:
(i) passing the unconditioned air through an air box comprising the engine intake air filter to condition the unfiltered air into the filtered air to be received by the engine and the fluid tank;
(ii) compressing the filtered air via a forced induction compressor operatively attached to the air box; and
(iii) passing the filtered air that is compressed to the fluid tank via the conduit from the air pathway.

19. The method of claim 18, wherein the forced induction compressor is at least partially provided by a compressor housing of a turbocharger.

20. The method of claim 18, further comprising:
(g) regulating a pressure level of the filtered air prior to being received by the fluid tank via a regulator located between the air pathway and the fluid tank; and
(h) releasing the filtered air that exceeds a maximum pressure threshold via a pressure release valve operatively installed to the fluid tank.
